(19) United States
(12) Patent Application Publication
(10) Pub. No.: US 2013/0318694 A1
(43) Pub. Date: Dec. 5, 2013

(54) CHEMICAL PROTECTIVE SUIT

(71) Applicants: Nobuo Shigematsu, Tokyo (JP); Akira Kamahori, Tokyo (JP)

(72) Inventors: Nobuo Shigematsu, Tokyo (JP); Akira Kamahori, Tokyo (JP)

(73) Assignee: SHIGEMATSU WORKS CO., LTD., Tokyo (JP)

(21) Appl. No.: 13/985,030

(22) PCT Filed: Feb. 10, 2011
(86) PCT No.: PCT/JP2011/052896

§ 371 Date: Aug. 12, 2013

(51) Int. Cl. A62B 17/00

(52) U.S. Cl. CPC A62B 17/006
USPC 2/457

(57) ABSTRACT

[Object of the Invention] An object of the present invention is to provide a chemical protective airtight suit for accommodating a self-contained breathing apparatus that is more comfortable to use than a conventional chemical protective airtight suit for accommodating a self-contained breathing apparatus, wherein the rear side of the head portion and the lower end of the portion accommodating the high pressure air vessel are not stretched, so that the user wearing the suit does not feel uncomfortable when the user crouches down, and the high pressure air vessel is not caught by the chemical protective airtight suit when the user takes off the suit.

[Disclosure of the Invention] A chemical protective airtight suit for accommodating a self-contained breathing apparatus comprises a head portion for covering the part of a human body extending from the top of the head to the neck, a body portion for covering the part of the human body extending from the chest to the abdomen, a pair of arm portions for covering the parts of the human body extending from the shoulders to the wrists, and a pair of leg portions for covering the parts of the human body extending from the abdomen to the calves, wherein the aforementioned portions are integrated in a unitary body, and cooperate with a pair of gloves for covering the parts of the human body extending from the wrists to the fingers and a pair of foot portions for covering the parts of the human body extending from the calves to the toes so as to protect the whole human body, and wherein the rear side of the head portion extends downward and rearward toward the rear side of the body portion opposing the high pressure air vessel accommodated in the chemical protective airtight suit.

### TECHNICAL FIELD

The present invention relates to a chemical protective airtight suit for accommodating a self-contained breathing apparatus.

### BACKGROUND ART

As shown in FIG. 1, a chemical protective airtight suit A for accommodating a self-contained breathing apparatus 100 is in use. The chemical protective airtight suit A comprises a head portion 1 for covering the part of a human body extending from the top of the head to the neck, a body portion 2 for covering the part of the human body extending from the chest to the abdomen, a pair of arm portions 3 for covering the parts of the human body extending from the shoulders to the wrists, and a pair of leg portions 4 for covering the parts of the human body extending from the abdomen to the calves. The aforementioned portions are integrated in a unitary body, and cooperate with gloves a connected to the arm portions beforehand so as to cover the parts of the human body extending from the wrists to the fingers and a pair of foot portions 6 integrated with the leg portions 4 in a unitary body or connected to the leg portions 4 beforehand so as to cover the parts of the human body extending from the calves to the toes, thereby protecting the whole human body. The rear side of the body portion 2 expands rearward so as to form a space for accommodating a high pressure air vessel 100a of the self-contained breathing apparatus 100. A user of the chemical protective airtight suit A is shut off from the environment.

In the conventional chemical protective airtight suit A for accommodating a self-contained breathing apparatus, the rear side 1a of the head portion 1 extends vertically downward to the height level of the base of the neck. The lower end of the rear side 1a connects with the rear side of the body portion 2 opposing the high pressure air vessel 100a through an upwardly protruding curved part extending along the top of the high pressure air vessel 100a. The aforementioned structure can minimize the dead space in the chemical protective airtight suit A worn by the user.

### DISCLOSURE OF INVENTION

### Problem to be Solved

The conventional chemical protective airtight suit A for accommodating a self-contained breathing apparatus has a problem in that a constriction 1a′ located between the lower end of the rear side 1a of the head portion 1 and the upwardly protruding curved part does not move in the direction outward of the suit when the user of the chemical protective airtight suit A crouches down, so that the rear side 1a of the head portion 1 and the lower end 1a′ of the portion accommodating the high pressure air vessel 100a are stretched to make the user feel uncomfortable. The discomfort becomes severe when the high pressure air vessel 100a accommodated in the suit A is large sized. The conventional chemical protective airtight suit A for accommodating a self-contained breathing apparatus has another problem in that the high pressure air vessel 100a is caught by the constriction 1a′ when the user takes off the chemical protective airtight suit A.

Therefore, an object of the present invention is to provide a chemical protective airtight suit for accommodating a self-contained breathing apparatus that is more comfortable to use than a conventional chemical protective airtight suit for accommodating a self-contained breathing apparatus, wherein the rear side of the head portion and the lower end of the portion accommodating the high pressure air vessel are not stretched and the user wearing the suit does not feel uncomfortable when the user crouches down, and the high pressure air vessel is not caught by the chemical protective airtight suit when the user takes off the suit.

### Means for Achieving the Object

In accordance with the present invention, there is provided a chemical protective airtight suit for accommodating a self-contained breathing apparatus comprising a head portion for covering the part of a human body extending from the top of the head to the neck, a body portion for covering the part of the human body extending from the chest to the abdomen, a pair of arm portions for covering the parts of the human body extending from the shoulders to the wrists, and a pair of leg portions for covering the parts of the human body extending from the abdomen to the calves, wherein the aforementioned portions are integrated in a unitary body, and cooperate with a pair of gloves for covering the parts of the human body extending from the wrists to the fingers and a pair of foot portions for covering the parts of the human body extending from the calves to the toes so as to protect the whole human body, and wherein the rear side of the head portion extends downward and rearward toward the rear side of the body portion opposing the high pressure air vessel accommodated in the chemical protective airtight suit.

In the chemical protective airtight suit for accommodating a self-contained breathing apparatus in accordance with the present invention, the rear side of the head portion extends downward and rearward toward the rear side of the body portion opposing the high pressure air vessel of the self-contained breathing apparatus accommodated in the chemical protective airtight suit so as to eliminate the constriction located between the lower end of the rear side of the head portion and the upwardly protruding curved part which causes the rear side of the head portion and the lower end of the portion for accommodating the high pressure air vessel to be stretched and the high pressure air vessel to be caught by the chemical protective airtight suit when the user takes off the chemical protective airtight suit. Therefore, the rear side of the head portion and the lower end of the portion accommodating the high pressure air vessel are not stretched, so that the user wearing the suit does not feel uncomfortable when the user crouches down, and the high pressure air vessel is not caught by the chemical protective airtight suit when the user takes off the suit. The chemical protective airtight suit for accommodating a self-contained breathing apparatus in accordance with the present invention is more comfortable to use than a conventional chemical protective airtight suit for accommodating a self-contained breathing apparatus.

In accordance with a preferred aspect of the present invention, the chemical protective airtight suit for accommodating a self-contained breathing apparatus further comprises a vertical partition accommodated in the head portion and fixed to the top of the head portion at the upper end and to either side of the head portion at either side end so as to divide the internal space of the head portion into a front portion for accommodating the head of the human body and a rear portion located above the high pressure air vessel.

When the vertical partition is disposed in the head portion, the head portion is prevented from deformation caused by transverse expansion and forward drooping.

In accordance with a preferred aspect of the present invention, the chemical protective airtight suit for accommodating a self-contained breathing apparatus further comprises a horizontal partition accommodated in the head portion and fixed to the lower end of the vertical partition at the front end and to the lower end of the slanted rear side of the head portion at the rear end.

When a large sized high pressure air vessel is used, the horizontal partition disposed in the head portion prevents the large sized high pressure air vessel from entering into a pocket-like space formed by the slanted rear side of the head portion, the opposite side ends of the head portion, and the vertical partition so as to interfere with an exhale valve disposed in the slanted rear side of the head portion.

Either side end of the horizontal partition is free. Therefore, a user of the chemical protective airtight suit for accommodating a self-contained breathing apparatus in accordance with the present invention can insert a hand into the pocket-like space formed by the vertical partition, the horizontal partition, the slanted rear side of the head portion and the opposite side ends of the head portion for maintenance of the exhale valve disposed in the rear side of the head portion.

### BRIEF DESCRIPTION OF THE DRAWINGS

FIG. 1 is a set of structural views of a conventional chemical protective airtight suit for accommodating a self-contained breathing apparatus. FIG. 1(a) is a front view and FIG. 1(b) is a view in the direction of arrows b-b in FIG. 1(a).

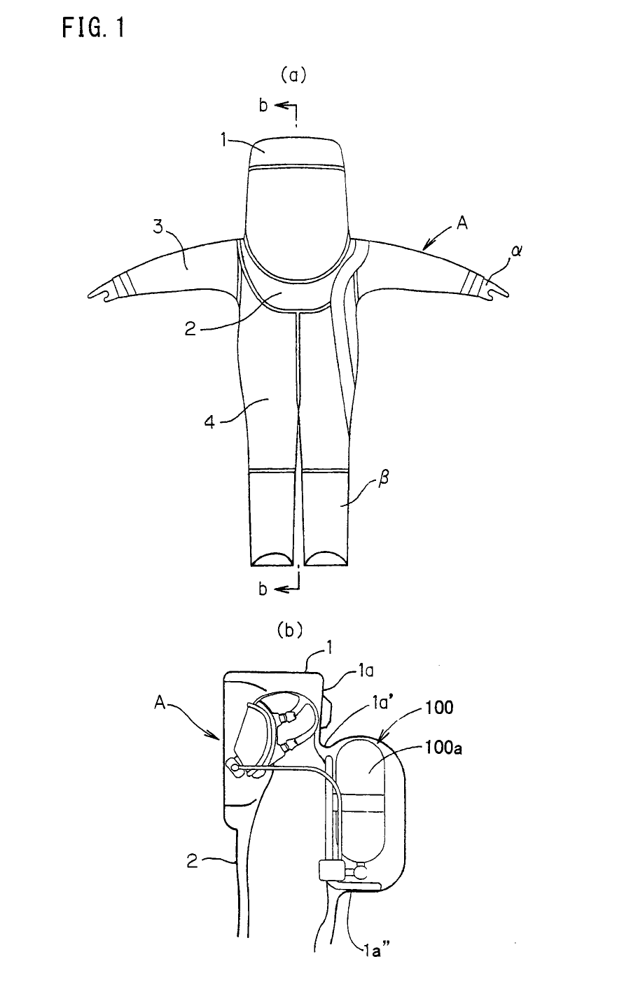

FIG. 2 is a set of structural views of a chemical protective airtight suit for accommodating a self-contained breathing apparatus in accordance with a preferred embodiment of the present invention. FIG. 2(a) is a view corresponding to FIG. 1(b), FIG. 2(b) is a view in the direction of arrows b-b in FIG. 2(a), and FIG. 2(c) is a view in the direction of arrows c-c in FIG. 2(b).

### MODES FOR CARRYING OUT THE INVENTION

A chemical protective airtight suit for accommodating a self-contained breathing apparatus in accordance with a preferred embodiment of the present invention will be described.

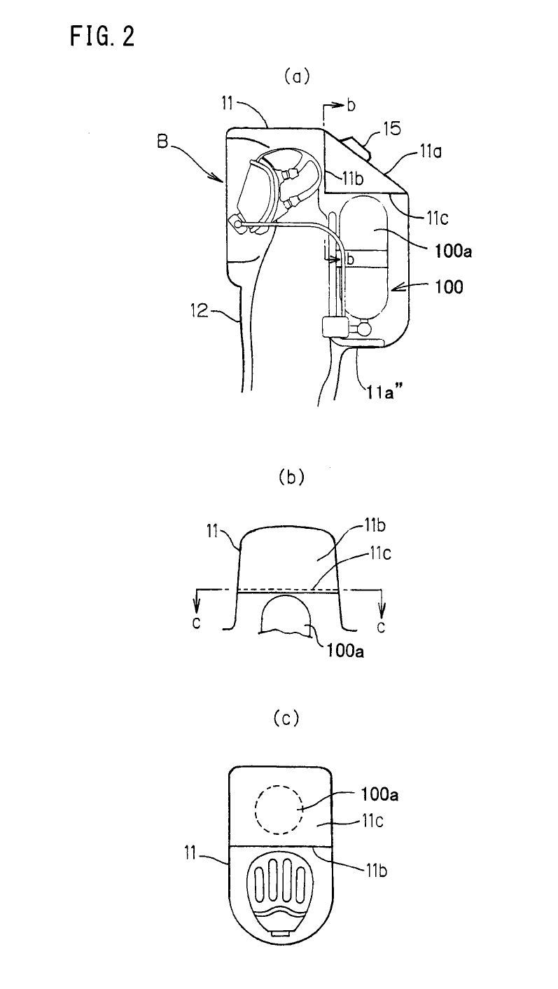

As shown in FIG. 2, a chemical protective airtight suit B for accommodating a self-contained breathing apparatus has the same structure as the chemical protective airtight suit A for accommodating a self-contained breathing apparatus. That is, the chemical protective airtight suit B comprises a head portion 11 for covering the part of a human body extending from the top of the head to the neck, a body portion 12 for covering the part of the human body extending from the chest to the abdomen, a pair of arm portions for covering the parts of the human body extending from the shoulders to the wrists, and a pair of leg portions for covering the parts of the human body extending from the abdomen to the calves. The aforementioned portions are integrated in a unitary body. The rear side of the body portion 12 expands rearward so as to form a space for accommodating a high pressure air vessel 100a of a self-contained breathing apparatus 100.

A rear side 11a of the head portion 11 extends downward and rearward toward the rear side of the body portion 12 opposing the high pressure air vessel 100a so as to connect to the upper end of the rear side of the body portion 12.

A vertical partition 11b is accommodated in the head portion 11. The vertical partition 11b is fixed to the rear end of the top of the head portion 11 at the upper end and to either side of the head portion 11 at either side end so as to divide the internal space of the head portion 11 into a front portion for accommodating the head of a user of the chemical protective airtight suit B and a rear portion located above the high pressure air vessel 100a.

A horizontal partition 11c is accommodated in the head portion 11. The horizontal partition 11c is fixed to the lower end of the vertical partition 11b at the front end and to the lower end of the slanted rear side 11a of the head portion 11 at the rear end.

The vertical partition 11b and the horizontal partition 11c are desirably formed of longitudinally and transversely extensible cloth material made of polyester resin or polyamide resin. The vertical partition 11b and the horizontal partition 11c can be formed of the same flexible sheet fabric that forms the chemical protective airtight suit B for accommodating a self-contained breathing apparatus.

In the chemical protective airtight suit B for accommodating a self-contained breathing apparatus, the rear side 11a of the head portion 11 extends downward and rearward toward the rear side of the body portion 12 opposing the high pressure air vessel 100a accommodated in the suit B so as to eliminate the constriction 1a′ located between the lower end of the rear side 1a of the head portion 1 and the upwardly protruding curved part of the conventional chemical protective airtight suit A for accommodating a self-contained breathing apparatus which causes the rear side 1a of the head portion 1 and the lower end 1a″ of the portion for accommodating the high pressure air vessel to be stretched and the high pressure air vessel 100a to be caught by the chemical protective airtight suit A when the user takes off the chemical protective airtight suit A. Therefore, the rear side 11a of the head portion and the lower end 11a″ of the portion accommodating the high pressure air vessel are not stretched, so the user wearing the airtight suit B does not feel uncomfortable when the user crouches down, and the high pressure air vessel 100a is not caught by the chemical protective airtight suit B when the user takes off the airtight suit B. The chemical protective airtight suit B for accommodating a self-contained breathing apparatus is more comfortable to use than a conventional chemical protective airtight suit A for accommodating a self-contained breathing apparatus.

The vertical partition 11b prevents the opposite side ends of the head portion 11 from moving away from each other and thus prevents transverse expansion of the head portion 11 during operation. The head of the user prevents the vertical partition 11b from moving forward and thus prevents forward drooping of the head portion 11. The head portion 11 is prevented from deformation during operation because the head portion 11 is prevented from transverse expansion and forward drooping during operation.

When a large sized high pressure air vessel 100a is used, the horizontal partition 11c abuts the top of the large sized high pressure air vessel 100a so as to prevent the large sized high pressure air vessel 100a from entering into a pocket-like space formed by the vertical partition 11b, the slanted rear side 11a of the head portion 11, and the opposite side ends of the head portion 11, thereby preventing the high pressure air vessel 100a from interfering with and damaging an exhale valve 15 disposed in the slanted rear side 11a of the head portion 11.

Either side end of the horizontal partition 11c is free. Therefore, the user of the chemical protective airtight suit B for accommodating a self-contained breathing apparatus can insert a hand into the pocket-like space formed by the vertical partition 11b, the horizontal partition 11c, the slanted rear side 11a of the head portion 11, and the opposite side ends of the head portion 11 for maintenance of the exhale valve 15 disposed in the rear side 11a of the head portion 11.

### INDUSTRIAL APPLICABILITY

The present invention can be widely used in a chemical protective airtight suit for accommodating a self-contained breathing apparatus.

### BRIEF DESCRIPTION OF THE REFERENCE NUMERALS

A, B Chemical protective airtight suit for accommodating a self-contained breathing apparatus

1, 11 Head portion

2, 12 Body portion

3 Arm portion

4 Leg portion

α Glove

β Foot portion

1a, 11a Rear side of the head portion

1a′ Constriction

1a″, 11a″ Lower end of the portion for accommodating the high pressure air vessel

11b Vertical partition

11c Horizontal partition

15 Exhale valve

1. A chemical protective airtight suit for accommodating a self-contained breathing apparatus comprising a head portion for covering the part of a human body extending from the top of the head to the neck, a body portion for covering the part of the human body extending from the chest to the abdomen, a pair of arm portions for covering the parts of the human body extending from the shoulders to the wrists, and a pair of leg portions for covering the parts of the human body extending from the abdomen to the calves, wherein the aforementioned portions are integrated in a unitary body, and cooperate with a pair of gloves for covering the parts of the human body extending from the wrists to the fingers and a pair of foot portions for covering the parts of the human body extending from the calves to the toes so as to protect the whole human body, and wherein the rear side of the head portion extends downward and rearward toward the rear side of the body portion opposing the high pressure air vessel accommodated in the chemical protective airtight suit.

2. A chemical protective airtight suit accommodating a self-contained breathing apparatus of claim 1, further comprising a vertical partition accommodated in the head portion and fixed to the top of the head portion at the upper end and to either side of the head portion at either side end so as to divide the internal space of the head portion into a front portion for accommodating the head of the human body and a rear portion located above the high pressure air vessel.

3. A chemical protective airtight suit accommodating a self-contained breathing apparatus of claim 2, further comprising a horizontal partition accommodated in the head portion and fixed to the lower end of the vertical partition at the front end and to the lower end of the slanted rear side of the head portion at the rear end.
